(19) United States
(12) Patent Application Publication
(10) Pub. No.: US 2003/0191860 A1
(43) Pub. Date: Oct. 9, 2003

(54) Accelerated collaboration of high frame rate applications

(76) Inventors: Krishna K. Gadepalli, Fremont, CA (US); Ihtisham Kabir, Los Altos, CA (US); Aastha Bhardwaj, Fremont, CA (US); Peter Farkas, Santa Cruz, CA (US); Paul R. Ramsey, Tucson, AZ (US)

Correspondence Address: Jeffrey C. Hood, Conley, Rose & Tayon, P.C., P.O. Box 398, Austin, TX, 78767, US

(21) Appl. No.: 10/117,703

(22) Filed: Apr. 5, 2002

(51) Int. Cl. G06F 15/16

(52) U.S. Cl. 709/247; 709/219; 709/203

(57) ABSTRACT

An application sharing and collaboration (ASC) system comprising a first computer, where the first computer is configured to execute a graphics application. The graphics application is configured to: (a) call a set of OpenGL rendering functions to render an image into a local buffer, and (b) call a particular OpenGL function which has been modified to induce compression of the image from the local buffer and transfer of the compressed image to a set of one or more remote systems. Each of the one or more remote systems may be configured to: decompress the compressed image, and display the decompressed image.

### BACKGROUND OF THE INVENTION

1. Field of the Invention

This invention relates generally to the field of application collaboration and, more particularly, to a system and method for sharing and collaborating on an image generating application.

2. Description of the Related Art

Conferencing and collaboration software are becoming commonplace. Within the field of collaboration, application sharing and collaborating on an application are two of the most widely used features. However, when trying to share or collaborate on an application which refreshes frames often (e.g., 15-30 frames per second), like most 3D graphics applications do, the collaboration software which exists today performs very poorly: frames are not refreshed at interactive speeds. Frames are refreshed only at about 1 frame per second. Thus, there exists a need for a system and methodology for increasing the frame rate for application sharing and collaboration systems.

In the traditional approach of application sharing, the sharing software may grab the frame data from the frame buffer of a local graphics accelerator using the XGetImage function. This mechanism is too slow to support interactive frame rates.

### SUMMARY OF THE INVENTION

One set of embodiments of a method for performing an application sharing and collaboration (ASC) conference through a computer network may be arranged as follows. Users at two or more computers each execute an ASC software application. The ASC software applications, running on the respective computers, enable the users at the two or more computers to share and/or collaborate on other software applications (e.g. graphics applications) running on their respective computers.

A first user of a first (i.e. an arbitrary one) of the two or more computers may then execute a graphics application on the first computer. The graphics application may render an image into a local buffer associated with the first computer (e.g. a local buffer resident in a graphics accelerator coupled to the first computer). Furthermore, the graphics application may call a swap buffer function to induce:

(a) transfer of the image from the local buffer to a precompress buffer in the system memory of the first computer,

(b) compression of the image in the precompress buffer, and

(c) transfer of the compressed image to remaining ones (i.e. ones other than the first computer) of the two or more computers.

The swap buffer function may present to the graphics application a calling interface that is identical to the calling interface defined for the standard OpenGL glXSwapBuffers function. Each of the remaining computers decompresses the compressed image, and displays the decompressed image on a corresponding display.

The graphics application may call OpenGL library functions such as glXChooseVisual, glXQueryExtension, glXGetConfig in an attempt to prepare for remote OpenGL rendering using an OpenGL graphics device (e.g. graphics accelerator) at a remote computer system. However, such OpenGL functions may be modified to provide information about a local OpenGL rendering device (e.g. a local graphics accelerator coupled to the local computer which executes the graphics application). Thus, the graphics application is fooled into thinking it is receiving information about some remote OpenGL graphics device.

In an attempt to create a graphics context associated with what it believes to be a remote OpenGL device, the graphics application may call glXCreateContext. However, the glXCreateContext function may be modified to create a context for the local OpenGL rendering device instead.

Furthermore, the glXMakeCurrent function is modified. Thus, when the graphics application attempts to attach the context to a window, the glXMakeCurrent function creates a local pbuffer (e.g. a pbuffer in the local graphics accelerator) and attaches the context to the local pbuffer. The graphics application is fooled into thinking that the context has been attached to a remote window associated with the remote computer system (e.g. associated with a remote OpenGL graphics device).

Because the context is attached to the local pbuffer, the standard OpenGL rendering functions do not require modification. Subsequent rendering will happen to the local pbuffer instead of to some remote window.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates a local computer system and a remote computer system coupled through a computer network;

FIG. 2 illustrates one embodiment of a method for arranging the transfer of compressed images to a remote computer system with image decompression and display to be performed at the remote computer system;

FIG. 3 illustrates a set of two or more computers coupled through a computer network;

FIG. 4 illustrates one embodiment of a method for rendering at a local computer system and displaying rendered images at a remote computer system;

FIG. 5 illustrates one set of embodiments of a system for performing application sharing and/or collaboration; and

FIG. 6 illustrates one embodiment of a method for performing application sharing and/or collaboration.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

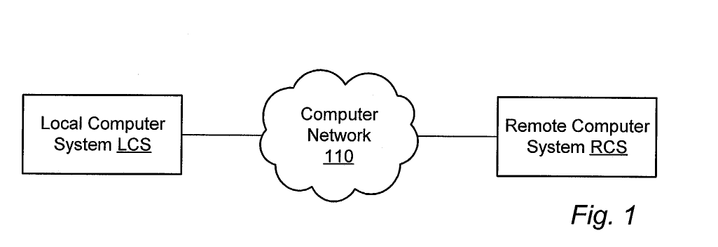

In one set of embodiments, a local computer system LCS and a remote computer RCS may be coupled through a computer network 110 as suggested by FIG. 1. For example, each computer system may have a network interface card to facilitate communication through the computer network 110. The computer network 110 may be a local area network, a wide area network, or a global network such as the Internet).

An application running on the local computer system LCS may generate (or access) an image, and call an XPutImage function to induce (a) transmission of the image to the remote computer system RCS through the computer network and (b) display of the image on a display associated with the remote computer system. An XServer running on the remote computer system (associated with the remote display) receives a protocol data stream (containing the image) in response to the XPutImage function call, and invokes the XPutImage executable code to display the image.

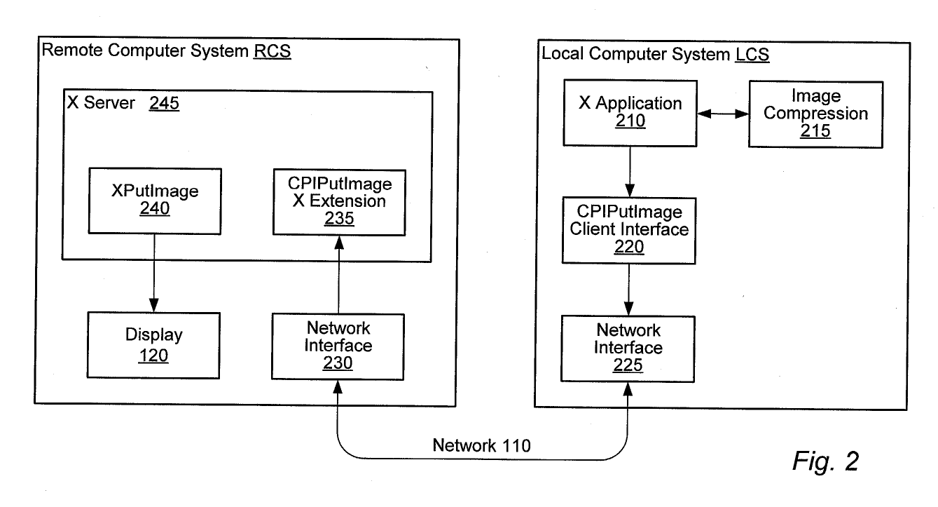

Because transmission bandwidth through the computer network 110 may be a limited resource, it may be desirable to send the images in compressed form. Unfortunately, the standard XPutImage code at the remote X server does not support image decompression. Thus, an X extension may be configured to allow transmission of compressed images as suggested by FIG. 2.

An X application 210 (i.e. any software application which is configured to make calls to X) running on the local computer system LCS may generate an image (or receive an image, or read an image from a memory, etc.), and call an image compression algorithm 215 to compress the image. After compressing the image, the X application may call a function CPIPutImage to induce transmission of the compressed image across the network to the remote X Server 245. The call to CPIPutImage invokes a client interface 220 which handles the transmission of the compressed image through the computer network 110 to the X Server 245. Local computer system LCS includes a network interface 225, and remote computer system RCS includes a network interface 230. The network interfaces represent any software and/or hardware required for communicating through computer network 110.

The remote X Server 245 receives a protocol data stream (containing the compressed image), and invokes the executable code 235 for the X extension function CPIPutImage in response to receiving the protocol data stream. The CPIPutImage function decompresses the compressed image (e.g. by calling a decompression algorithm which is complementary to the compression algorithm 215), and calls the executable code 240 for the standard X internal PutImage operation to display the decompressed image.

The X extension allows applications to remotely display images by calling the function CPIPutImage which has an interface very similar to the XPutImage function, except that each image is provided to the CPIPutImage function in compressed form. The extension includes the following functions:

| int CPIQueryVersion(Display* dpy) | |
|---|---|
| int CPIPutImage( | Display* dpy, |
| | Drawable d, |
| | GC gc, |
| | int destx, |
| | int desty, |
| | unsigned int width, |
| | unsigned int height, |
| | int format, |
| | unsigned char* data, |
| | unsigned int length) |

The variables dpy, d, gc, destx, desty, width, and height are identical to the corresponding variables defined for the XPutImage function. The variable format is a number identifying the compression format to be used. The variable data is a pointer to the compressed data. The variable length is the length in bytes of the compressed data.

The X extension 235 which runs in the X server 245 is quite simple. It receives the compressed data, decompresses the compressed data, and then calls the standard X internal PutImage operation 240 (already included in the X server) to display the decompressed image. By storing the appropriate state information in the extension, the extension may support interframe decompression.

The value of this extension is that with the extension in place, it isn't necessary for a separate application to be running on the remote computer system RCS to be able to rapidly display images over the network. This makes it easy to implement on a variety of platforms as long as the platforms support the X window system protocol and allow for extensions.

When used in conjunction with a network appliance (e.g. a SunRay™), the X extension may forward the data to the appliance without decompression. Thus, the appliance may perform the decompression.

Any of a variety of codecs (compression/decompression algorithms) may be used to compress/decompress the image data. In one embodiment, the extension may use the codec disclosed in:

U.S. patent application Ser. No. 09/779,333, entitled “Entropy coding using Adaptable Prefix Codes”, filed on Feb. 8, 2001, invented by Russ Brown.

This patent application is hereby incorporated by reference in its entirety.

The variable format allows for the selection of a codec from a set of stored codecs. In some embodiments, one value of the variable format may be use to indicate that the image being passed to the CPIPutImage function has not been compressed.

It is noted that the X application 210 may be configured to generate (or access) a sequence of images, each of which is to be displayed on the remote display (at the remote computer system). Thus, the X application 210 may perform the compression operation and the call to the CPIPutImage function for each image in the image sequence.

The X application 210 may generate the image which is to be remotely displayed. For example, in one embodiment, the X application may be a graphics application configured to generate the image by asserting rendering commands through a graphics API (application programmer's interface) such as OpenGL.

In another embodiment, the X application 210 may access the image from a memory medium (such as random access memory, read only memory, CD-ROM, magnetic tape, magnetic disk, or any combination thereof).

In yet another embodiment, the X application 210 may receive the image from a video capture device coupled to a video camera.

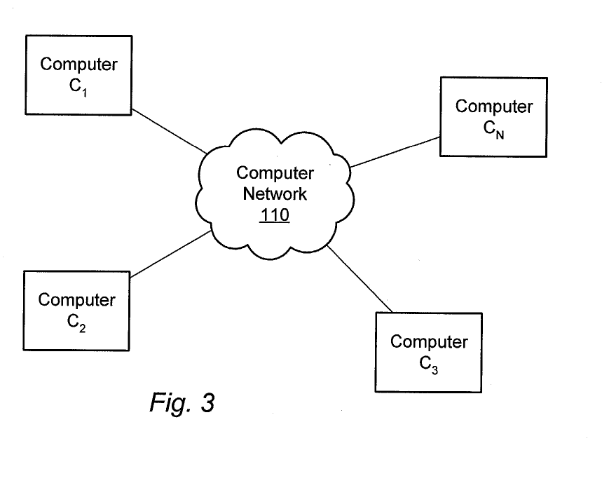

In one set of embodiments, a set of computer systems C₁, C₂, . . . , C_{N} may be coupled through a computer network 110 (e.g. a local area network, wide area network, or the Internet), where N is an integer greater than or equal to two, as suggested by FIG. 3. An application running on any computer system C_{I} of the N computer systems may remotely display images on any other computer system C_{J} of the N computer systems (i.e. I not equal to J) by the system and methodology described above. Furthermore, an application running on computer system C_{J} may remotely display images on computer system C_{I} may the same mechanism.

In one embodiment, computer system C, may display remotely on two or more of the N computer systems by calling the CPIPutImage function two or more times respectively.

The present invention contemplates storage media for storing the X extension code and/or the client interface disclosed herein. Any of a variety of storage media are contemplated including CD-ROM, semiconductor read-only memory (ROM) and/or random access memory (RAM), magnetic disk, magnetic tape, bubble memory.

As disclosed in the various embodiments described herein, an X extension may be configured to support the rapid transfer and display of images on a remote system by allowing the images to be sent in compressed form with the X extension doing the decompression once the image has been sent.

Local Rendering and Remote Display

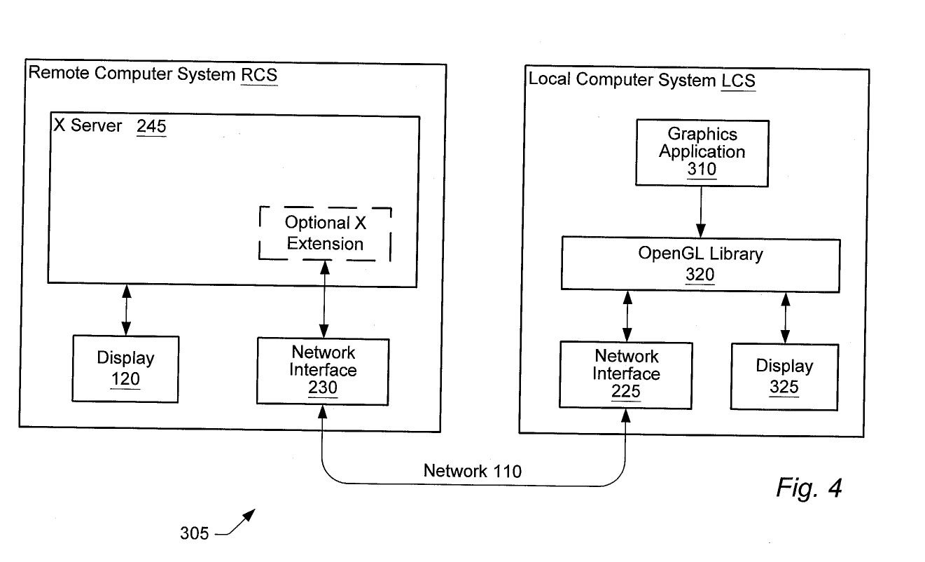

In one set of embodiments, a graphics application 310 executing on the local computer system LCS may make calls to the OpenGL Library 320 as shown in FIG. 4. FIG. 4 illustrates a system 105 for rendering graphics images locally at the local computer system LCS and displaying the graphics images remotely on the remote computer system RCS.

Rather than sending graphics commands over the network 110, and rendering on the remote computer system RCS (e.g. on a graphics accelerator coupled to the remote computer system RCS), the commands may be automatically redirected to a local device (e.g. a graphics accelerator coupled to the local computer system LCS) without explicit involvement by the graphics application 310.

After the graphics application has completed the rendering of a frame, the graphics application may call a library function (such as glXSwapBuffers or glFinish) to induce transfer of the frame across the network 110 to the remote computer system RCS, and display of the frame on the remote display 120.

Several of the OpenGL library functions may be modified as described below to support the operation of system 305. In some embodiments, the remote computer system RCS may use a standard X Server to support the operation of system 305. In one embodiment, a modified X server on the remote computer system RCS may allow for more efficient image transmission through the use of image compression.

The following OpenGL client functions may be modified to allow local rendering and remote display in a manner which is transparent to the graphics application 310.

glXChooseVisual( ), glXQueryExtention( ), glXGetConfig( ), and other query functions are modified to return information about local graphics capabilities associated with the local computer system LCS (e.g. about a local graphics accelerator coupled to the local computer system LCS) rather than information about remote graphics capabilities associated with the remote computer system RCS. With this modified information, most graphics applications will be willing to create windows for the remote system for use with OpenGL even though the remote system may not actually have any OpenGL capabilities (or may not have sufficient OpenGL capabilities).

glXCreateContext may be modified so that when the graphics application attempts to create an OpenGL context for use with a remote window, a context is instead created for the local graphics accelerator.

glXMakeCurrent may be modified so that when the graphics application attempts to attach the context to a window, a local pbuffer of the same size as the OpenGL viewport is created, and the context is attached to the pbuffer instead of the remote window.

glViewport( ) is modified so that if the viewport size is changed, the pbuffer size is changed accordingly.

Because the context is attached to the pbuffer, the standard OpenGL rendering functions do not require modification. Subsequent OpenGL rendering will thereby target the pbuffer instead of the remote window.

glFinish( ) and glXSwapBuffers( ) are modified so that when the graphics application calls either of them, the rendered image is (a) read back from the local graphics device using glReadPixels( ) or a device specific function, and (b) displayed on the remote system using XPutImage or any other convenient remote image display function, possibly using compression to reduce the transmission time.

glFlush( ) can also be modified for single buffered applications.

In some embodiments, the glXSwapBuffers function (and the glFinish function) may be modified to:

(a) call the glReadPixels function (or an image access function specific to the graphics accelerator being used) to read the image from the pbuffer into a host memory buffer (i.e. a buffer in the system memory of the local computer system LCS);

(b) call a compression function to compress the image from the host memory buffer; and

(c) call the CPIPutImage function to induce transfer of a data stream containing the compressed image to the X Server running on the remote computer system RCS.

As described above, in response to receiving the data stream, the remote X Server may invoke an X extension program corresponding to the CPIPutImage function. The X extension program decompresses the compressed image and invokes the standard X internal PutImage operation to display the decompressed image.

A device specific image access function may be able to configure or command the resources in the local graphics accelerator to perform one or more processing operations on the image from the pbuffer in addition to simply reading the image out of the pbuffer. These one or more processing operations may assist in the image compression process.

In one embodiment, the pbuffer already resides in host system memory. Thus, in this embodiment, the call to glReadPixels or the device specific image access function is not necessary.

When local rendering and remote display is enabled, and a graphics application associates a remote window with a graphics context, an identical sized pbuffer is created on a local graphics device and all OpenGL rendering which was intended for the window is done to the pbuffer instead. When the graphics application calls glXSwapBuffers (or glFinish) to display the rendering results, the image is read back from the local graphics device and optionally compressed to be sent to the remote system for display.

Application Sharing and Collaboration

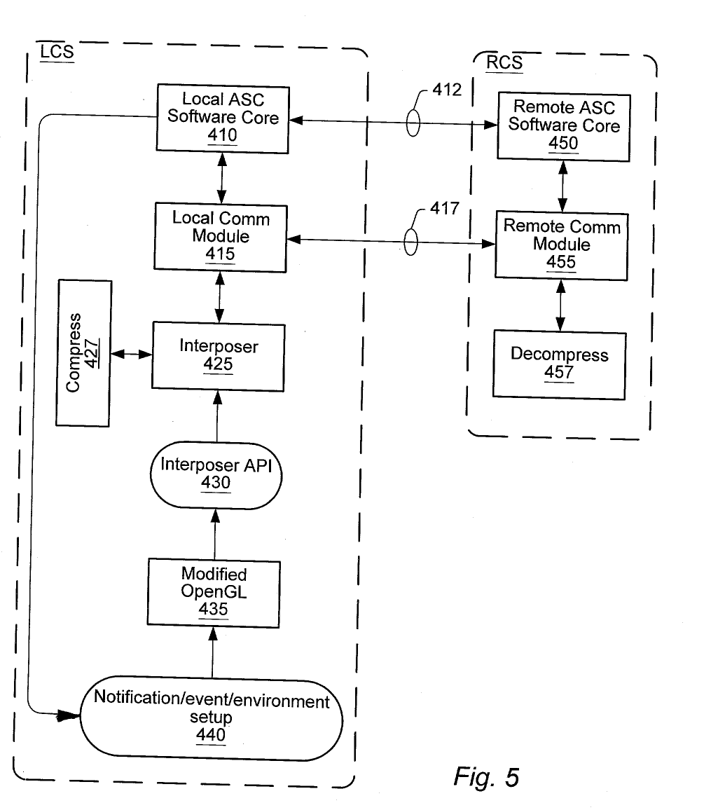

In one set of embodiments, a system for application sharing and collaboration (ASC) may be configured from several component pieces as suggested by FIG. 5 to accelerate the frame rate when sharing (or collaborating on) one or more applications which generate image sequences (such as graphics applications).

In the follow discussion, application sharing and collaboration will be described in terms of two participants. However, it is noted that the number of participants in the ASC conference does not need to be restricted to two, and the ASC system may be configured to operate with any number of participants.

The local computer system LCS and the remote computer system RCS each execute an ASC software core (e.g. software similar to the SunForum product). The ASC software cores 410 and 450 set up a sharing and collaboration conference connection 412 between the local computer system and the remote computer system. In sharing mode, a user of the local computer system (remote computer system) may share the display output of applications running on the local computer system (remote computer system) with a user of the remote computer system (local computer system). In collaboration mode, the user of the local computer system (remote computer system) may allow the user of the remote computer system (local computer system) to take control of applications running on the local computer system (remote computer system).

The notation “ . . . A(B) . . . . C(D) . . . ” in a sentence may be interpreted as two separate sentences of the form “ . . . A . . . C . . . ” and “ . . . B . . . D . . . ”.

Each ASC software core couples to a corresponding communication module. The local ASC software core is configured to “provide” certain information it has from the X protocol relevant to the application to be shared via a local communication module.

Suppose that an application to be shared, e.g. a graphics application, is running on the local computer system LCS. The local communication module 415 establishes communication between the local ASC software core 410 and the interposer 425 (to be explained shortly), in order to obtain the frame data. At the remote computer system RCS, the remote communication module 455 establishes communication between the remote ACS software core 450 and the display mechanism (i.e. the channel on which the frame data is “received” and being displayed). Because of this architecture, the enhanced application sharing and/or collaboration of OpenGL applications will be transparent to users, for whom it would look as if they just chose a mode of application sharing which is much more efficient.

The interposer communicates with OpenGL via a defined interface. The interposer receives the frame data from OpenGL before the frame data is displayed on the local computer system. This may be accomplished in either of two ways:

making an internal modification to OpenGL which allows the interposer to access a copy of the frame data from OpenGL; or

pre-loading a library which allows the interposer to catch the parameters and data of certain OpenGL calls.

The interposer receives each frame from memory as soon as the Open GL application has it ready. By receiving the frame data from OpenGL, a lot of time is saved relative to the traditional approach of application sharing.

Note that this inventive principles described herein may be applied to libraries or frameworks other than OpenGL.

Following the data path, the next step is to compress the frame data (i.e. the image data). The interposer may call a compression function 427 to compress the frame data. Any of a number of codecs (compression/decompression algorithms) may be used to realize the compression function. In one embodiment, a user may select a codec to be used. In one embodiment, the compression function may be configured as a pluggable module in the interposer. The codec (compression/decompression algorithm) may have a compression ratio, an image fidelity after the decompression, and a computational complexity that is well balanced to match the network bandwidth, the system's performance, the need for accurate frames, and the need for interactive frame rates.

In one embodiment, the codec disclosed in U.S. patent application Ser. No. 09/779,333, entitled “Entropy coding using Adaptable Prefix Codes”, filed on Feb. 8, 2001, invented by Russ Brown, as be used to realize the compression function.

In some embodiments, each frame may be compressed separately. The compression is performed on the local computer system prior to transmission across the network.

Note that there are certain internal optimizations which may be implemented. For example, compression of one frame may be performed, while another frame is being received from OpenGL, and while yet another frame (which has already been compressed) is being transferred to the remote computer system. In one embodiment, the codec may be tuned to the CPU of the local computer system.

Since the data is compressed with a relatively high compression ratio, network transmission bandwidth is used more efficiently. Thus, the ACS system may support a higher frame transfer rate than prior art application sharing systems.

Next, the communication module 415 sends the compressed frame to the communication module 455 through the communication path 417, and induces decompressed and display of the compressed frame at the remote computer system RCS. There are several possible ways of doing this.

In one set of embodiments, an X Server extension is implemented on the remote computer system RCS. The X Server extension allows the local computer system LCS system to request that the remote computer system accept compressed image data, decompress the compressed image data, and display the decompressed image data. This X Server extension is referred to herein as the XcompressedPutImage extension (or equivalently, as the CPIPutImage extension).

The local communication module 415 receives the compressed image from the interposer 425, and calls the CPIPutImage function to induce transfer of the compressed image to the remote X Server running on the remote computer system RCS. The CPIPutImage extension at the remote X Server handles the decompression of the image and the display of the decompressed image on the display of the remote computer system. (The CPIPutImage extension may call a decompression function 457 which is complementary to the compression function 427 in order to decompress the compressed image, and invoke the standard X internal PutImage operation to display the decompressed image at the remote computer system.) Note that this is a significant optimization: since the remote computer system has only to decompress and display the image, it can achieve a substantially higher frame rate than it could otherwise, i.e. than if it had to produce the images in the first place.

In one alternative embodiment, the application sharing channel 412 may be used to send the compressed frame data the remote computer system.

In another alternative embodiment, instead of relying on an X protocol based communication mechanism between the local and remote systems, the communication module 415 may open another channel, but perform the same basic steps: copy/send over the compressed data, decompress it, and display the frames using the relevant X protocol information.

In one embodiment, the ACS system may use multicast protocols to save network traffic when there are a large number of participants in the conference.

In some embodiments, the ASC software running on the local computer system signals the host application to prepare for remote OpenGL rendering at the remote computer system. The graphics application may be configured to call a set of OpenGL configuration functions (such as glXChooseVisual, glXQueryExtension, glXGetConfig, glXCreateContent, glXMakeCurrent) in response to said signaling. The set of OpenGL configuration functions may be modified to create and attach a context for a local graphics accelerator to the local pbuffer instead of creating and attaching a context for remote graphics hardware to a remote buffer at the remote computer system.

To introduce the basic ideas, the discussion above has focused on a graphics application running on the local computer system, where the ASC software and the communication modules allow the graphics application to rendering frames at the local computer system and the display the frames at the remote computer system. However, it is should be understood that the ASC software and the communication modules may be configured in a symmetric fashion, so that a graphics application running on the remote system may render on the remote computer system and display on the local computer system.

The local ASC core 410 and the remote ASC core 450 negotiate call setup for the conferencing connection 412. The local ASC core 410 communicates create and setup information and synchronization information with the local communication module 415. The local communication module and remote communication module may send/receive handshaking signals as OpenGL image data across the communication connection 417.

The local communication module 415 may communicate window management information with interposer 425 as well as compressed frame data (i.e. image data).

The interposer application programming interface (API) 430 is an interface between the interposer 425 and the modified OpenGL library 435.

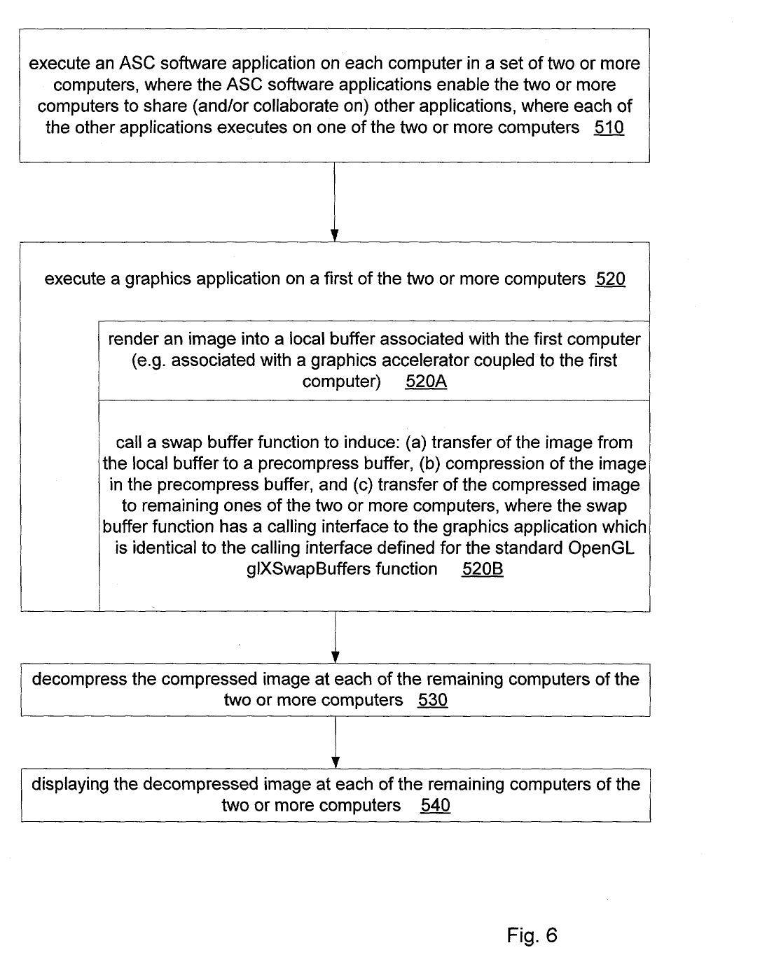

FIG. 6 illustrates one embodiment of a method for performing an application sharing and collaboration (ASC) conference through a computer network. In step 510, users at two or more computers each execute an ASC software application. The ASC software applications, running on the respective computers, enable the users at the two or more computers to share and/or collaborate on other software applications (e.g. graphics applications) running on their respective computers.

In step 520, a first user of a first of the two or more computers may execute a graphics application on the first computer. The graphics application may render an image into a local buffer associated with the first computer (e.g. resident in a graphics accelerator coupled to the first computer) as indicated in step 520A. Furthermore, the graphics application may call a swap buffer function as indicated in step 520B to induce:

(a) transfer of the image from the local buffer to a precompress buffer in the system memory of the first computer,

(b) compression of the image in the precompress buffer, and

(c) transfer of the compressed image to remaining ones of the two or more computers.

The swap buffer function may present to the graphics application a calling interface that is identical to the calling interface defined for the standard OpenGL glXSwapBuffers function.

In step 530, each of the remaining computers decompresses the compressed image. In step 540, each of the remaining computers displays the decompressed image. Various methods for decompressing and displaying the image at the remote computers has been described above. Please refer to those discussions.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

What is claimed is:

1. A method comprising:
(a) calling a set of OpenGL rendering functions to render an image into a local buffer;
(b) calling a particular OpenGL function, wherein the particular OpenGL function has been modified to induce compression of the image from the local buffer and transfer of the compressed image to a set of one or more remote systems;
(c) decompressing the compressed image at each of the one or more remote systems; and
(d) displaying the decompressed image at each of the one or more remote systems;

2. The method of claim 1, wherein the particular OpenGL function induces transfer of the compressed image to a first of the one or more remote systems by calling a modified version of the XPutImage function.

3. The method of claim 2, wherein said calling the modified XPutImage function induces an X Server at the first remote system to decompress the compressed image and to display the decompressed image on a first display coupled to the first remote system.

4. The method of claim 1, wherein (a) and (b) are performed by a host application executing on a host computer.

5. The method of claim 4, wherein the host application is a graphics application.

6. The method of claim 4, wherein the local buffer resides in a graphics accelerator coupled to the host computer, wherein the particular OpenGL function calls a glReadPixels function to transfer the image from the local buffer to a host memory buffer of the host computer prior to said compression, wherein said compression operates on the image in the host memory buffer.

7. The method of claim 4, wherein the host computer and the one or more remote computers are coupled through a computer network.

8. The method of claim 4, further comprising executing application sharing and collaboration (ASC) software on the host computer and each of the one or more remote systems, wherein the ASC software is configured to setup a conferencing connection between the host computer and the one or more remote systems.

9. The method of claim 8 further comprising the ASC software signaling the host application to prepare for remote OpenGL rendering at a first of the one or more remote systems, wherein the host application is configured to call a set of OpenGL configuration functions in response to said signaling, wherein the set of OpenGL configuration functions are modified to create and attach a context for a local graphics accelerator to the local buffer instead of creating and attaching a context for remote graphics hardware to a remote buffer at the first remote system.

10. The method of claim 1, wherein the particular OpenGL function is a modified version of the glXSwapBuffers function.

11. A method comprising:
executing a first application on a first computer and a second application on a second computer, wherein the first application and the second application enable the first computer to share one or more other applications, executing on the first computer, with the second computer;
executing a graphics application on the first computer, wherein said executing the graphics application includes calling a number of OpenGL functions which render a graphics image into a memory associated with the first computer;
activating an interposer to (a) access the graphics image from the memory, (b) compress the graphics image, and (c) send the compressed image to the second computer;
decompressing the compressed image at the second computer; and
displaying the decompressed image at the second computer.

12. The method of claim 11, wherein the memory resides in a graphics accelerator coupled to the first computer.

13. The method of claim 11, wherein the first and second application further enable the first computer and the second computer to collaborate on the one or more application executing on the first computer.

14. The method of claim 11, wherein said activating the interposer comprises the graphics application calling a modified version of the glXSwapBuffers function, wherein the modified version has the same calling interface as the standard glXSwapBuffers function.

15. A method comprising:
executing a first application on a first computer and a second application on a second computer, wherein the first application and the second application enable one or more third applications executing on the first computer to be shared with the second computer;
executing graphics application of said one or more third applications on the first computer, wherein said executing the graphics application includes:
rendering an image into a local buffer associated with the first computer;
calling a swap buffer function to induce (a) transfer of the image from the local buffer to a precompress buffer, (b) compression of the image in the precompress buffer, and (c) transfer of the compressed image to the second computer, wherein the swap buffer function has an interface to the graphics application which is identical to the interface defined for the standard OpenGL glXSwapBuffers function.
decompressing the compressed image at the second computer; and
displaying the decompressed image at the second computer.

16. The method of claim 15, wherein the first application and the second application allow a first user at the first computer and a second user at the second computer to collaborate on the one or more other applications executing on the first computer.

17. The method of claim 15, wherein the local buffer is a pbuffer.

18. The method of claim 15, wherein the first computer and the second computer are coupled through a computer network.

19. A method comprising:
executing a first application on each computer in a set of two or more computers, wherein the first applications enable the two or more computers to share second applications, wherein each of the second applications executes on one of the two or more computers;
executing a graphics application on a first of the two or more computers, wherein said executing the graphics application includes:
rendering an image into a local buffer associated with the first computer;
calling a swap buffer function to induce (a) transfer of the image from the local buffer to a precompress buffer, (b) compression of the image in the precompress buffer, and (c) transfer of the compressed image to remaining ones of the two or more computers, wherein the swap buffer function has a calling interface to the graphics application which is identical to the calling interface defined for the standard OpenGL glXSwapBuffers function.
decompressing the compressed image at each of the remaining computers of the two or more computers; and
displaying the decompressed image at each of the remaining computers of the two or more computers.

20. A communication system comprising:
a first computer, wherein the first computer is configured to execute a graphics application, wherein the graphics application is configured to:
(a) call a set of OpenGL rendering functions to render an image into a local buffer;
(b) call a particular OpenGL function, wherein the particular OpenGL function has been modified to induce compression of the image from the local buffer and transfer of the compressed image to a set of one or more remote systems;
said set of one or more remote systems, wherein each of said one or more remote systems is configured to:
(c) decompress the compressed image; and
(d) display the decompressed image.

21. The communication system of claim 20, wherein, in response to execution of collaboration software, the first computer and the set of one or more remote computers allow respective users to collaborate and share the graphics application.

22. A memory medium configured to store program instructions, wherein the program instructions define a modified OpenGL function which is executable by a processor to implement:
(a) transfer of an image from local buffer in a local graphics accelerator to a precompress buffer in a system memory of the processor;
(b) compression of the image in the precompress buffer; and
(c) transfer of the compressed image to one or more remote computers.

23. The memory medium of the claim 22, wherein the modified OpenGL function is a function that has an identical calling interface as the standard glXSwapBuffers function.

24. The memory medium of claim 22, wherein the modified OpenGL function is a function that has an identical calling interface as the standard glFinish function.
